(19) United States
(12) Patent Application Publication
(10) Pub. No.: US 2019/0085893 A1
(43) Pub. Date: Mar. 21, 2019

(54) Spherical Automotive Joint with Improved Grease Access

(71) Applicant: Clayton Kraatz, Irricana (CA)

(72) Inventor: Clayton Kraatz, Irricana (CA)

(21) Appl. No.: 16/126,500

(22) Filed: Sep. 10, 2018

Related U.S. Application Data
(60) Provisional application No. 62/561,434, filed on Sep. 21, 2017.

(51) Int. Cl. F16C 11/06; B60G 7/00

(52) U.S. Cl. CPC F16C 11/068; B60G 7/005

(57) ABSTRACT

A spherical automotive joint features a housing, and a ball member with a spherically contoured ball head received in the housing and a stud that is attached to and projects from the ball head to a location situated externally of the housing at a spaced distance therefrom. A grease passage enters the stud of the ball member at a location outside the housing, reaches through the stud into the ball member, and exits the ball member at one or more locations inside the housing to enable greasing of the joint via the stud.

### CROSS-REFERENCE TO RELATED APPLICATIONS

This application claims benefit under 35 U.S.C. 119(e) of U.S. Provisional Application No. 62/561,434, filed Sep. 21, 2017, the entirety of which is incorporated herein by reference.

### FIELD OF THE INVENTION

The present invention relates generally to spherical automotive joints such as ball joints.

### BACKGROUND

In the automotive field, ball joints are typically greased through grease ports provided in the housing of the joint. However, access to these grease ports can be difficult in the installed position of the ball joints in its intended application, and so it would be desirable to provide a unique ball joint design to which grease can be applied from a different access point.

### SUMMARY OF THE INVENTION

According to one aspect of the invention, there is provided a spherical automotive joint comprising:

a housing;

a ball member comprising a spherically contoured ball head received in the housing in a position embraced by spherically concave surfaces inside the housing to enable rotation and tilting of the ball member relative to the housing, and a stud that is attached to and projects from the ball head to a point situated externally of the housing at a spaced distance therefrom; and

a grease passage entering the stud of the ball member at a location outside the housing, reaching through the stud into the ball member and exiting the ball member at one or more locations inside the housing to enable greasing of the joint via the stud of the ball member.

Preferably the grease passage comprises an enlarged area at an input end thereof at which said grease passage enters the stud of the ball member, said enlarged area accommodating recessed mounting of a grease fitting within the stud at the input end of the grease passage.

Preferably the grease passage enters the stud of the ball member at a distal end of the stud furthest from the ball head.

Preferably the grease member comprises multiple outlets exiting the ball head in different directions.

Preferably the grease member comprises at least one longitudinal outlet exiting the ball head at an end of the ball member opposite the stud.

Preferably the grease member comprises at least one lateral outlet exiting the ball member through a side thereof.

Preferably the housing contains separate first and second races defining the spherically concave surfaces inside the housing, and the grease passage comprises at least one outlet exiting the ball head at a location between the first and second races.

Preferably the housing has an open end through which the ball member extends to place the stud at least partially outside the housing, and a closed end situated opposite said open end, and the grease passage comprises at least one outlet facing the closed end of the housing.

Preferably the at least one outlet facing the closed end of the housing exits the ball head at a location between the closed end of the housing and an adjacent race that neighbours the closed end of the housing and defines some of the spherically concave surfaces embracing the ball member.

### BRIEF DESCRIPTION OF THE DRAWINGS

One embodiment of the invention will now be described in conjunction with the accompanying drawings in which:

FIG. 1 is a cross-sectional view of a ball joint of the present invention with a unique grease passage that enters the housing of the joint through a stud of the joint's ball member.

### DETAILED DESCRIPTION

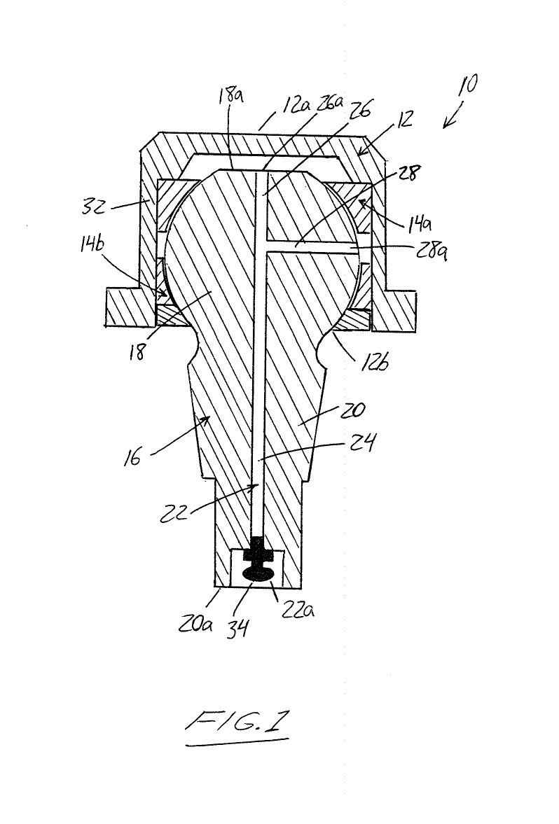

FIG. 1 shows a ball joint 10 of the present invention, which in a known manner features a housing 12, a pair of races or seats 14 disposed within an interior space of the housing 12, and a ball member 16 partially received within the housing and projecting outward therefrom. The two races 14 include a first upper race 14a situated nearest a closed top end 12a of the housing, and a second lower race 14b situated nearest an opposing open bottom end 12b. The ball member 16 transitions between the interior and exterior of the housing through the open end 12b thereof. The ball member 16 features a ball head 18, at least a substantial majority of which is contained within the housing, and whose exterior is spherically convex on all sides thereof. An elongated stud or stem 20 of the ball member 14 is integrally attached to the ball head 18 and projects longitudinally therefrom in direction reaching outwardly away from the open end of the housing so that a distal end 20a of the stud 20 is located externally of the housing at a spaced distance therefrom.

The spherically contoured exterior sides of the ball head 18 are embraced by spherically concave surfaces of the first upper race 14a that face downwardly toward the open bottom end 12b of the housing, and also by spherically concave surfaces of the second lower race 14b that face upwardly toward the closed top end 12a of the housing 12. It will be appreciated that the terms upper, lower, top and bottom are used herein only in relation to the illustrated orientation of the joint in FIG. 1, and are not intended to limit the invention to a particular orientation during use. In known manner, this embracement of the spherically convex ball head 18 by the spherically concave race surfaces inside the housing 12 allows the ball member to rotate and tilt relative to the housing 12, whereby the projecting stud 20 of the ball member 16 can move into different angular positions relative the housing 12.

Conventionally, the ability to introduce grease into the ball joint during post-assembly servicing of the ball joint in the installed state of its intended application is provided by way of grease ports at the closed end 12a of the housing. The present invention departs from this conventional setup by additionally or alternatively providing an internal grease passage 22 in the ball member 14 to allow introduction of grease into the housing via the projecting stud 20.

An input end 22a of the grease passage opens into the ball member 14 at the distal end 20a of the stud furthest from the ball head 18. From here, the grease passage has a main path 24 that extends axially through the stud on a central longitudinal axis thereof and into the center of the ball head 18. Here, the grease passage of the illustrated embodiment branches into two different outlet paths, a first longitudinal outlet path 26 forming an axial extension of the axial main path 24, and a second radial outlet path 28 branching radially outward from the main path 24 in a direction perpendicular thereto at a mid-plane of the ball head. At this mid-plane, perpendicular measurement of the ball head's diameter relative to the stud's longitudinal axis is at its greatest.

The first axial outlet path defines a longitudinal outlet 26a of the grease passage 22 at an end 18a of the ball situated axially furthest from the stud, so that this outlet faces the closed end of the housing. In the illustrated embodiment, this end 18a of the ball head is a flattened end having a planar surface lying normal to the longitudinal axis of the stud, while the remainder of the ball head possesses the spherically convex curvature for cooperative sliding interface with the conformingly concave race surfaces. The longitudinal outlet 26a of the grease passage thus opens up the housing interior at a location between the closed upper end 12a of the housing and the neighbouring first upper race 14a adjacent thereto, thus delivering grease to the first upper race and the internal end 18a of the ball member 16.

The second lateral outlet path 28 defines a radial outlet 28a of the grease passage 22 at one of the spherically contoured sides of the ball head 18. In the illustrated position of the ball member 14, where the central longitudinal axis thereof aligns with a central longitudinal axis of the housing (i.e. the axis on which the cylindrical circumferential wall 32 of the housing is centered), the radial outlet 28a of the grease passage resides at a location between the two races 14a, 14b to ensure greasing the lower second race 14b that is not directly fed by the longitudinal outlet 26a of the grease passage.

It will be appreciated that the longitudinal and radial outlet paths need not necessarily be parallel and perpendicular to the longitudinal axis of the ball, respectively, and may instead angle obliquely therefrom any of a number of possible directions. Therefore, it will also be apparent that the lateral outlet path 28 need not necessarily reside in the described mid-plane of the ball head 18.

The illustrate use of at least one longitudinal outlet path 26 that exits the ball member at the internal end 18a thereof and faces the closed end 12a of the housing 12 together with at least one lateral outlet path 28 that exits the side of the ball member 18 ensures thorough grease distribution to both the upper and lower races. However, in other embodiments, the grease passage may instead have only a singular outlet in the ball member. Alternatively, the number out outlets may be increased from the two shown in the drawing, for example to include multiple lateral output paths exiting through different sides of the ball head.

The cross-sectional area of the grease passage is enlarged at the inlet end 22a of the grease passage 22, where the main path 24 is drilled out to a greater diameter to create a cylindrical counter-bore. This counter-bored recess in the distal end 20a of the stud 20 accommodates mounting of a grease fitting 34 in the inlet end of the grease passage in a manner fully recessed inside the stem so as not to project beyond the distal end thereof.

Also, while the illustrated embodiment employs a housing with separate internal races installed therein, it will be appreciated that the stud-routed grease passage may likewise be used for ball joints that instead have the spherically concave surfaces defined directly by the housing, and not by separate internal components contained therein.

Since various modifications can be made in my invention as herein above described, and many apparently widely different embodiments of same made, it is intended that all matter contained in the accompanying specification shall be interpreted as illustrative only and not in a limiting sense.

1. A spherical automotive joint comprising:
a housing;
a ball member comprising a spherically contoured ball head received in the housing in a position embraced by spherically concave surfaces inside the housing to enable rotation and tilting of the ball member relative to the housing, and a stud that is attached to and projects from the ball head to a point situated externally of the housing at a spaced distance therefrom; and
a grease passage entering the stud of the ball member at a location outside the housing, reaching through the stud into the ball member and exiting the ball member at one or more locations inside the housing to enable greasing of the joint via the stud of the ball member.

2. The spherical joint of claim 1 wherein the grease passage comprises an enlarged area at an input end thereof at which said grease passage enters the stud of the ball member, said enlarged area accommodating recessed mounting of a grease fitting within the stud at the input end of the grease passage.

3. The spherical joint of claim 1 wherein the grease passage enters the stud of the ball member at a distal end of the stud furthest from the ball head.

4. The spherical joint of claim 1 wherein the grease member comprises multiple outlets exiting the ball head in different directions.

5. The spherical joint of claim 1 wherein the grease member comprises at least one longitudinal outlet exiting the ball head at an end of the ball member opposite the stud.

6. The spherical joint of claim 1 wherein the grease member comprises at least one lateral outlet exiting the ball member through a side thereof.

7. The spherical joint of claim 1 wherein the housing contains separate first and second races defining the spherically concave surfaces inside the housing, and the grease passage comprises at least one outlet exiting the ball head at a location between the first and second races.

8. The spherical joint of claim 1 wherein the housing has an open end through which the ball member extends to place the stud at least partially outside the housing, and a closed end situated opposite said open end, and the grease passage comprises at least one outlet facing the closed end of the housing.

9. The spherical joint of claim 8 wherein the at least one outlet facing the closed end of the housing exits the ball head at a location between the closed end of the housing and an adjacent race that neighbours the closed end of the housing and defines some of the spherically concave surfaces embracing the ball member.
